(19) United States
(12) Patent Application Publication
(10) Pub. No.: US 2010/0088270 A1
(43) Pub. Date: Apr. 8, 2010

(54) DATA VERSIONING CONCEPT INCLUDING TIME DEPENDENCY AND ACTIVE AND INACTIVE STATES

(76) Inventor: CARSTEN ZIEGLER, Walldorf (DE)

Correspondence Address: SAP AG, 3410 HILLVIEW AVENUE, PALO ALTO, CA, 94304, US

(21) Appl. No.: 12/244,794

(22) Filed: Oct. 3, 2008

(51) Int. Cl. G06F 17/30; G06F 9/44

(52) U.S. Cl. 707/609; 717/116; 707/E17.044

(57) ABSTRACT

A method and a system are described that involve data versioning with time dependency and active and inactive states. In one embodiment, the method includes creating a first version of an object in an application, wherein the application supports a versioning mode. The versioning mode maintains a set of versions of an object. The method further includes activating the first version of the object at a first timestamp and activating a second version of the object at a second timestamp in the versioning mode switched on. The first timestamp and the second timestamp define a validity period of the first version. Finally, the first version of the object is provided upon a request, wherein the request includes a timestamp in the validity period of the first version.

In one embodiment, the system includes an application that supports a versioning mode, an object with a set of versions, and a database to store the set of versions of the object with versioning information, wherein the versioning information includes a validity period, a timestamp, and a version state. The version state indicates if a version from the set of versions is active or inactive. The system also includes a unit to switch from the versioning mode to a non-versioning mode in the application.

### FIELD OF INVENTION

Embodiments of the invention relate generally to the software arts, and, more specifically, to a data versioning concept including time dependency and active and inactive states.

### BACKGROUND

Versioning is a term used for the creation and management of multiple releases of a product, all of which have the same general function but are improved, upgraded or customized. The term applies especially for operating systems, software, and management of data.

Version control is a general term used for keeping track of different versions of electronic information. It also ensures collaborative data sharing and editing among users of systems that employ different versions of a product. It is most commonly used in engineering and software development to manage ongoing development of digital documents such as application source code, art resources such as blueprints or electronic models, and other projects. Version control systems are usually stand-alone applications.

There are multiple data versioning concepts. Some of them support active and inactive data versions but with the possibility of having only one active version at a point of time. The term “active” means that a particular version is used for any operational processing, while inactive data is used only for modeling. Temporary or incomplete data cannot be used for operational processing. Although, there is always only one active version, there may be several inactive versions. A user may decide to activate one version and by doing so, to inactivate the previously active version. Thus, there cannot be multiple active versions and the user can process only the current active version.

### FIGURES

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a diagram of an embodiment for creating data versions with timestamps.

FIG. 2 is a diagram of an embodiment for creating rules to maintain versions of an object from a specific point of time.

FIG. 3 is a flow diagram of an embodiment for creating versions of an object with the versioning mode switched on and off.

FIG. 4 is a diagram of an embodiment for creating versions of an object with timestamps and with the versioning mode switched on and off.

### SUMMARY

A computing system and method for data versioning with time dependency and active and inactive states are described. In one embodiment, the method includes creating a first version of an object in an application, wherein the application supports a versioning mode. The versioning mode maintains a set of versions of an object. The method further includes activating the first version of the object at a first timestamp and activating a second version of the object at a second timestamp in the versioning mode switched on. The first timestamp and the second timestamp define a validity period of the first version. Finally, the first version of the object is provided upon a request, wherein the request includes a timestamp in the validity period of the first version.

In one embodiment, the system includes an application that supports a versioning mode, an object with a set of versions, and a database to store the set of versions of the object with versioning information, wherein the versioning information includes a validity period, a timestamp, and a version state. The version state indicates if a version from the set of versions is active or inactive. The system also includes a unit to switch from the versioning mode to a non-versioning mode in the application.

### DETAILED DESCRIPTION

Embodiments of the invention relate to a method and a system for data versioning including time dependency and supporting states active and inactive.

Versioning of data is a powerful concept that allows users to track changes, keep and work on old versions of data, and manage a number of versions or a specific version upon a request. In one embodiment of the invention, the versioning concept can be implemented as an additional functionality, or unit, in a graphical user interface (GUI) of an application. This unit can be in the form of a button, tab, link, or any other GUI element that can be used to execute the versioning concept. The versioning concept can be switched on and off in the application. Thus, the user can decide which data to keep track of.

In addition, the versioning concept includes time dependency. Each version of a data object is created and activated with a timestamp. Thus, the user can access older versions of the object by providing a timestamp. In one embodiment of the invention, the versioning concept may be used for maintaining history of data.

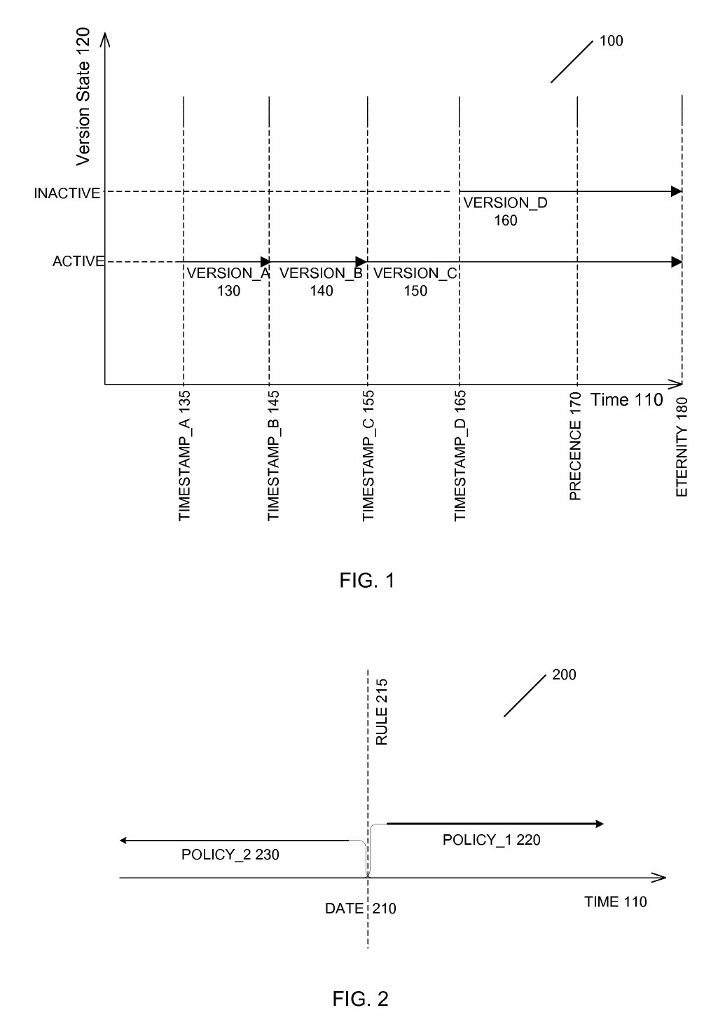

FIG. 1 is a diagram of an embodiment for creating data versions with timestamps. Diagram 100 includes two axes: Time 110 and Version State 120. Time 110 includes a number of timestamps at which a version was created. The Version State 120 shows the state of the created versions, active or inactive. The active state indicates that a version has been activated after it had been created. Diagram 100 shows the process of creating a number of versions of an object at different time points with the versioning mode switched on. In one embodiment, the process starts with a user that creates an object. Thus, he or she automatically creates version_A 130 of the object. The user may assign a value to the object, e.g. “ABC”, and some short text. In one embodiment, the user activates version_A 130 at timestamp_A 135. For example, the timestamp is 2008.06.12-02.15.38 (yyyy.mm.dd-hh.mm.ss). Initially, each version is inactive. Therefore, version_A 130 was inactive before timestamp_A 135. Version_A 130 is active until a new version of the object is created and activated.

At some point of time, the user decides to change the value of the object “ABC” to “XYZ”. Upon this change, version_B 140 is created. Version_B 140 of the object is activated at timestamp_B 145 (for example, 2008.06.23-03.10.18). Version_B 140 is active until version_C 150 is created and activated. Version_C 150 is activated at timestamp_C 155 (for example, 2008.07.13-05.04.00). If no other version is activated, version_C 150 is valid until eternity 180.

At timestamp_D 165 (for example, 2008.07.24-03.15.48), the user changes the value of the object to “LMN”. A new version_D 160 is created. The user saves the version but does not activate it. Version_D 160 is inactive until the user activates it.

The creation of the versions of the object is briefed in the following table.

| Event | State | Timestamp | Version | Value | Text |
|---|---|---|---|---|---|
| Create new object | Inactive | 2008.06.12-02.05.18 | version_A | ABC | Text_ABC |
| Activate version_A | Active | 2008.06.12-02.15.38 | version_A | ABC | Text_ABC |
| Change value and | Active | 2008.06.23-03.10.18 | version_B | XYZ | Text_XYZ |
| activate version_B | | | | | |
| Change value and | Active | 2008.07.13-05.04.00 | version_C | HIJ | Text_HIJ |
| activate version_C | | | | | |
| Change value and | Inactive | 2008.07.24-03.15.48 | version_D | LMN | Text_LMN |
| save version_D | | | | | |

Referring back to FIG. 1, at present 170 of the time axis 110, there are two current versions: version_C 150 and version_D 160. However, version_D 160 is not active. If a user sends a request to process the object and the request includes a timestamp after 2008.07.24-03.15.48, the versioning concept will return the last activated version, which is version_C 150. If the request includes a timestamp between 2008.06.23-03.10.18 and 2008.07.13-05.04.00, the versioning concept will return version_B 140. If no active version can be found for a specific timestamp, then a processing exception occurs.

The versioning concept processes activated versions and the last active version (e.g. version_C) is valid until eternity 180 as long as no further version is activated. Activation of a version does not mean that a save operation to a database is performed. Changes on the object will be saved to a database only upon a save operation. The versioning concept provides a possibility for an application to process activated versions even if they are not saved.

In one embodiment of the invention, the user request may not include any timestamp. If the request is to process the object, for example, to execute a rule or a set of rules on the object, then the versioning concept will return the last activated version of the object (e.g., version_C). If the request is to maintain the object, for example, to create a set of rules, the versioning concept will display the properties of the last saved version (e.g., version_D). In addition, the versioning concept can keep track of properties such as names of objects, texts, short texts, and so on.

FIG. 2 is a diagram of an embodiment for creating rules to maintain versions of an object from a specific point of time. In an embodiment, a user may need to modify an object for a particular time period or to apply some rules from a certain point of time. The versioning concept supports such time dependency. Diagram 200 presents the time dimension with time axis 110. The time axis 110 includes date 210 (for example, Jun. 12, 2008). On date 210, a policy concerning a particular object is changed. The user may need to apply a new policy_1 220 on the object from date 210. At the same time, the user may need to apply the old, or different, policy_2 230 on the object before date 210. Therefore, the user can create a new version of the object on date 210 and add a rule 215. Rule 215 helps the user to process the object from date 210. For example, the rule may be in the form: “>06.12.2008 do this else do that.” This means that if the creation date of a version is greater than 06.12.2008, then the object can be processed according to the new policy_1 220. Otherwise, the object will be processed according policy_2 230. An old version of the object can also be invoked by providing a timestamp before date 210. It should be appreciated that there may be different forms of rules and the one described above is only an example of such rule.

The versioning concept includes two methods that provide the user with more information about the versions of a particular object. The first method is called “GET_VERSIONS”. This method returns a table with specific details about all versions existing for a particular object. This method may also provide the last version that has been saved to a database. The second method is called “GET_ACTIVE_VERSION”. This method returns the last activated version of an object.

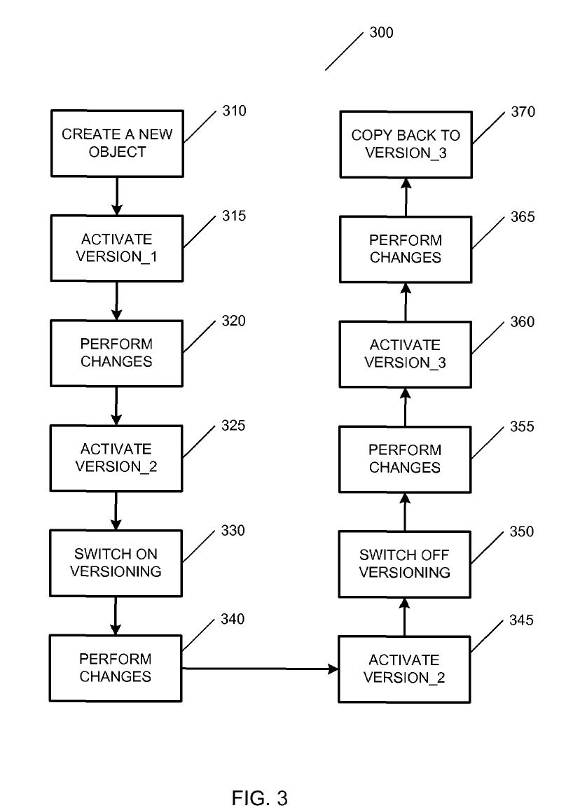

FIG. 3 is a flow diagram of an embodiment for creating versions of an object with the versioning mode switched on and off. Process 300 describes the versioning concept integrated in an application as a versioning mode. In an embodiment, the versioning mode of the application is initially switched off. The process 300 begins at block 310. At block 310, a new object is created. Automatically, version_1 of the object is created. At block 315, version_1 is activated. Activation of a version does not mean that the version is saved to a database. The activation step means that the state of the version has been changed from “inactive” to “active”. Initially, all versions are with state “inactive”. When the versioning mode in an application is switched on, the application processes only active versions of an object. Therefore, a version has to be activated to be available for processing.

At block 320, some changes are performed on version_1 of the object. These changes may include, but are not limited to, changing the value of an object, changing the text describing the object, and so on. Upon the performed changes, a second version of the object is created (e.g., version_2). The second version is initially inactive and located in a temporary storage. At block 325, version_2 is activated. Because the versioning mode of the application is switched off, all new active versions are copied back to the first active version created in non-versioning mode. Thus, version_2 overwrites version_1 and version_2 is also deleted from the temporary storage. In case there is not a version created in the non-versioning mode (i.e., version_1 does not exist), a new active version is created. Copying back versions also implies that an inactive version with a number, active version number+1, is deleted from the database. Therefore, version_2 is copied back to version_1 and, if version_2 was saved to the database prior to the activation, it is also deleted from the database. Thus, only version_1 exists and stays as active.

At block 330, the versioning mode in the application is switched on. Some changes are performed on version_1 at block 340. Upon the performed changes, a new second version of the object is created (e.g., version_2). At block 345, version_2 is activated and saved to the database. The versioning mode is switched off at block 350. At block 355, additional changes are performed. Upon the performed changes, a third version of the object is created (e.g., version_3). At block 360, version_3 is activated. Version_3 is the first active version created in non-versioning mode. At block 365, some changes are performed on version_3. The last changes create a forth inactive version of the object, version_4. Version_4 overwrites version_3, thus version_3 contains the last changes. No other active versions can be created in the non-versioning mode. Any new changes will be copied back to the first active version in the non-versioning mode, i.e., version_3.

When a new version of an object is activated, excluding the first version, the upper border of the previous version is set to meet the lower border of the new active version. For example, version_2 begins exactly at the moment where version_1 ends and version_2 ends at the moment version_3 is activated. The new active version is valid until eternity or until another new version is activated. Thus, there are no time gaps between the active versions.

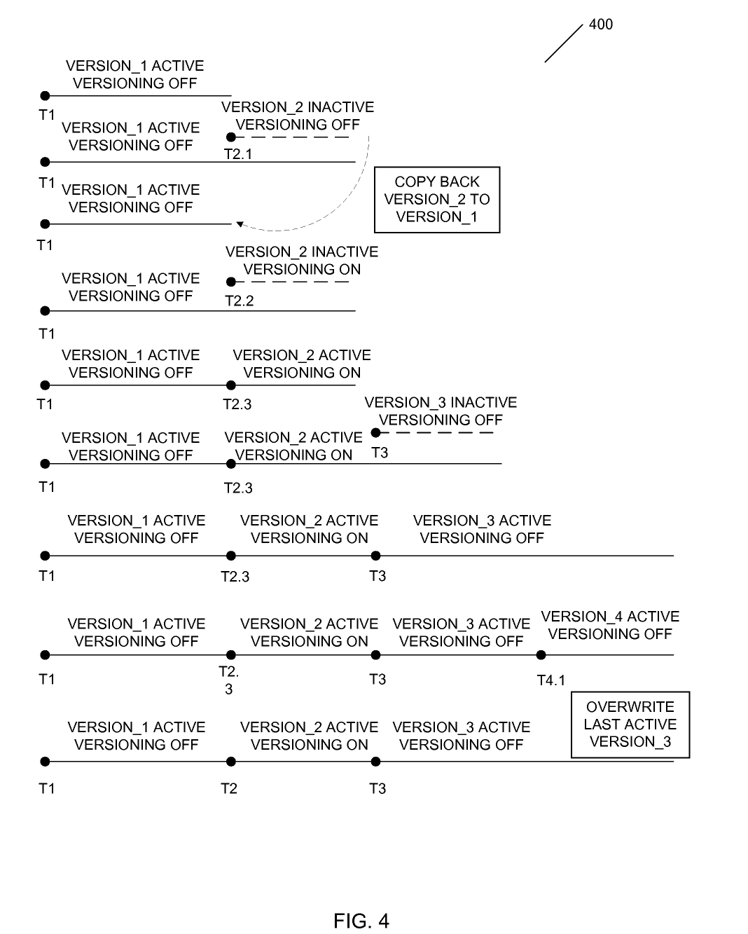

FIG. 4 is a diagram of an embodiment for creating versions of an object with timestamps and with the versioning mode switched on and off. Diagram 400 illustrates process 300, described in accordance with FIG. 3, enhanced with timestamps. Diagram 400 follows the same steps as described in FIG. 3. Version_1, version_2, version_3, and version_4 are presented at the time of creation and activation. The first axis shows that at the beginning of the process, only version_1 is created and activated. This corresponds to the creation of an object. The versioning mode is switch off. Version_1 is activated at timestamp t1. Version_2 is created at timestamp t2.1. At timestamp t2.2, versioning mode is switched on. At timestamp 2.3, version_2 is activated. Version_1 is active from t1 to t2.3. Versioning mode is switched off. At timestamp t3, version_3 is activated. Version_2 is active from t2.3 to t3. At timestamp t4.1, version_4 is created. Version_4 is copied back to version_3 and deleted. Version_3 is active from t3 till eternity 180 (or until the versioning mode is switched back on and a new version is activated).

The time period during which a version was active is defined as a validity period. For example, for version_2, the validity period is from timestamp t2.3 to t3. Therefore, if a user sends a request and the request includes a timestamp in the validity period of version_2, then version_2 will be returned to the user. If the user sends a request without a timestamp, the returned version will be version_3, in case the request is to process the object. Otherwise, if the request is to maintain the object, then version_4 will be returned.

Each saved object is stored in a database table with a key, a value, and versioning information. The versioning information may include, but is not limited to, a validity period, a version state, and a timestamp. There can be several data sets for several versions of one object. In an embodiment, these several versions may be all active at the same time. In another embodiment, these versions may be all inactive at the same time.

Elements of embodiments may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, embodiments of the invention may be downloaded as a computer program, which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. A method comprising:
creating a first version of an object in an application, the application to support a versioning mode;
activating the first version of the object at a first timestamp;
activating a second version of the object at a second timestamp in the versioning mode, wherein the first timestamp and the second timestamp define a validity period of the first version; and
providing the first version of the object upon a request, the request to include a timestamp in the validity period of the first version.

2. The method of claim 1 further comprising:
storing in a database table the first version of the object with versioning information, the versioning information to include the validity period of the first version, the first timestamp, and a version state, the version state to indicate if the first version is active.

3. The method of claim 2, wherein activating comprises setting the version state to active.

4. The method of claim 1 further comprising:
activating the second version of the object in a non-versioning mode;
overwriting the first version of the object with the second version in response to activating the second version; and
deleting the second version in response to overwriting the first version.

5. The method of claim 1 further comprising:
providing the second version of the object upon the request if the request does not include any timestamp, wherein the second version is a last activated version of the object.

6. The method of claim 1 further comprising:
providing a last saved version of the object upon the request, the request to maintain the object and not to include any timestamp.

7. The method of claim 1, further comprising:
receiving a rule for processing the object with a second request, the rule to include a point of time;
performing a first policy on a subset of the set of versions of the object created before the point of time of the rule; and
performing a second policy on a remaining subset of the set of versions of the object, the remaining subset of the set of versions created after the point of time of the rule.

8. A computing system comprising:
an application that supports a versioning mode;
an object with a set of versions;
a database to store the set of versions of the object with versioning information, the versioning information to include a validity period, a timestamp, and a version state, the version state to indicate if a version from the set of versions is active; and
a unit to switch from the versioning mode to a non-versioning mode in the application.

9. The computing system of claim 8, further comprising:
a first version of the object activated at a first timestamp; and
a second version of the object activated at a second timestamp in the versioning mode, wherein the first timestamp and the second timestamp define the validity period of the first version.

10. The computing system of claim 9, wherein the first version is provided to a request that includes the timestamp in the validity period of the first version.

11. The computing system of claim 8, wherein a last activated version of the object is provided to a request if the request does not to include any timestamp.

12. The computing system of claim 8, wherein a last saved version of the object is provided to a request, the request to maintain the object.

13. The computing system of claim 9, wherein the second version of the object is activated in a non-versioning mode.

14. The computing system of claim 13, wherein the second version overwrites the first version in the database after the second version is activated.

15. The computing system of claim 14, wherein the second version is deleted from the database after it overwrites the first version.

16. The computing system of claim 8, further comprising:
a rule for processing the object received with a request, the rule to include a point of time;
a first policy performed on a subset of the set of versions of the object created before the point of time of the rule; and
a second policy performed on a remaining subset of the set of versions of the object, the remaining subset of the set of versions created after the point of time of the rule.

17. A computer-readable storage medium having instructions therein that when executed by the machine, cause the machine to:
create a first version of an object in an application, the application to support a versioning mode;
activate the first version of the object at a first timestamp;
activate a second version of the object at a second timestamp in the versioning mode, wherein the first timestamp and the second timestamp define a validity period of the first version; and
provide the first version of the object upon a request, the request to include a timestamp in the validity period of the first version.

18. The computer-readable storage medium of claim 17 having instructions that when executed further cause the machine to:
store in a database table the first version of the object with versioning information, the versioning information to include the validity period of the first version, the first timestamp, and a version state, the version state to indicate if the first version is active.

19. The computer-readable storage medium of claim 18, wherein instructions causing the machine to activate comprise instructions causing the machine to set the version state to active.

20. The computer-readable storage medium of claim 17 having instructions that when executed further cause the machine to:
activate the second version of the object in a non-versioning mode;
overwrite the first version of the object with the second version in response to activating the second version; and
delete the second version in response to overwriting the first version.

21. The computer-readable storage medium of claim 17 having instructions that when executed further cause the machine to:
provide the second version of the object upon the request if the request does not include any timestamp, wherein the second version is a last activated version of the object.

22. The computer-readable storage medium of claim 17 having instructions that when executed further cause the machine to:
provide a last saved version of the object upon the request, the request to maintain the object and not to include any timestamp.

23. The computer-readable storage medium of claim 28 having instructions that when executed further cause the machine to:
receive a rule for processing the object with a second request, the rule to include a point of time;
perform a first policy on a subset of the set of versions of the object created before the point of time of the rule; and
perform a second policy on a remaining subset of the set of versions of the object, the remaining subset of the set of versions created after the point of time of the rule.
